(19) United States
(12) Patent Application Publication
(10) Pub. No.: US 2016/0150488 A1
(43) Pub. Date: May 26, 2016

(54) UPLINK POWER CONTROL METHOD AND APPARATUS THEREOF

(71) Applicant: Huawei Technologies Co., Ltd., Shenzhen (CN)

(72) Inventors: Zezhou LUO, Shenzhen (CN); Ruslan GILIMYANOV, Shenzhen (CN); Hongcheng ZHUANG, Shenzhen (CN)

(21) Appl. No.: 15/011,230

(22) Filed: Jan. 29, 2016

Related U.S. Application Data
(63) Continuation of application No. PCT/CN2013/080586, filed on Aug. 1, 2013.

(51) Int. Cl. H04W 52/42; H04W 52/24; H04W 52/22

(52) U.S. Cl. CPC H04W 52/42; H04W 52/225; H04W 52/241

(57) ABSTRACT

Embodiments of the disclosure provide an uplink power control method and an apparatus thereof. The method includes: optimizing uplink power control parameters of the multiple cells according to a KPI model, where the KPI model is used to indicate a mapping relationship between the uplink power control parameters of the multiple cells and at least one KPI of a network on which the multiple cells are located; and performing uplink power control on user equipment in the multiple cells according to the uplink power control parameters of the multiple cells. In the embodiments of the disclosure, by considering impact of uplink power control parameters of multiple cells on a KPI of a network on which the multiple cells are located, uplink power control parameters that are more optimized from the perspective of global performance of the network are obtained, thereby improving overall performance of the network.

### CROSS-REFERENCE TO RELATED APPLICATIONS

This application is a continuation of International Patent Application No. PCT/CN2013/080586, filed on Aug. 1, 2013, which is hereby incorporated by reference in its entirety.

### TECHNICAL FIELD

Embodiments of the disclosure relate to the field of wireless communications, and in particular, to an uplink power control method and an apparatus thereof.

### BACKGROUND

In an existing cellular network, when an orthogonal frequency division multiplex (OFDM) technology is used, signals of user equipments (UE) within a cell are orthogonal to each other and do not interfere with each other, but signals of UEs in different cells interfere with each other.

Uplink power control is a control manner of controlling an uplink transmit power of UE while considering both service quality of the UE and interference of the UE to a UE of a neighboring cell.

In an existing uplink power control manner, an uplink power control parameter of UE is adjusted mainly according to local information such as link quality of the UE and interference of a transmit power of the UE to a neighboring cell; such uplink power control improves only service quality of local UE, but does not help improve overall network performance.

### SUMMARY

Embodiments of the disclosure provide an uplink power control method and an apparatus thereof, to improve overall network performance.

According to a first aspect, an uplink power control method is provided, including: optimizing uplink power control parameters of the multiple cells according to a key performance indicator (KPI) model, where the KPI model is used to indicate a mapping relationship between the uplink power control parameters of the multiple cells and at least one KPI of a network on which the multiple cells are located; and performing uplink power control on user equipment in the multiple cells according to the uplink power control parameters of the multiple cells.

With reference to the first aspect, in one implementation manner of the first aspect, the optimizing uplink power control parameters of the multiple cells according to a KPI model includes: creating a first optimization model according to the KPI model, where the first optimization model uses the uplink power control parameters of the multiple cells as optimization variables, and uses an optimal solution of the at least one KPI within a value range of the uplink power control parameters as an optimization target; and solving the first optimization model, to acquire uplink power control parameters of the multiple cells.

With reference to the first aspect or any one of the foregoing implementation manners, in another implementation manner of the first aspect, the at least one KPI is multiple KPIs, and the creating a first optimization model according to the KPI model includes: determining the uplink power control parameters of the multiple cells as optimization variables of the first optimization model; and determining a minimum weighted value of the multiple KPIs as an optimization target of the first optimization model.

With reference to the first aspect or any one of the foregoing implementation manners, in another implementation manner of the first aspect, the solving the first optimization model includes: mapping the optimization variables of the first optimization model from a discrete parameter space to a continuous parameter space, and converting a target function of the first optimization model into a continuous and smooth function, to acquire a second optimization model after conversion; determining a solution of the optimization variables in the continuous parameter space according to the second optimization model; and mapping the solution of the optimization variables in the continuous parameter space back to the discrete parameter space, to determine a solution of the optimization variables in the discrete parameter space.

With reference to the first aspect or any one of the foregoing implementation manners, in another implementation manner of the first aspect, the uplink power control parameters of the multiple cells include an uplink power control reference value of each cell of the multiple cells, and an uplink path loss compensation factor of each cell.

With reference to the first aspect or any one of the foregoing implementation manners, in another implementation manner of the first aspect, the at least one KPI of the network includes at least one of the following: uplink load, a call drop and block ratio (CDBR), and an average uplink signal to interference plus noise ratio.

According to a second aspect, an uplink power control apparatus is provided, including a processing unit, configured to optimize uplink power control parameters of the multiple cells according to a KPI model, where the KPI model is used to indicate a mapping relationship between the uplink power control parameters of the multiple cells and at least one KPI of a network on which the multiple cells are located; and a control unit, configured to perform uplink power control on user equipment in the multiple cells according to the uplink power control parameters of the multiple cells that are acquired by the processing unit.

With reference to the second aspect, in one implementation manner of the second aspect, the processing unit is specifically configured to create a first optimization model according to the KPI model, where the first optimization model uses the uplink power control parameters of the multiple cells as optimization variables, and uses an optimal solution of the at least one KPI within a value range of the uplink power control parameters as an optimization target; and solve the first optimization model, to acquire uplink power control parameters of the multiple cells.

With reference to the second aspect or any one of the foregoing implementation manners, in another implementation manner of the second aspect, the at least one KPI is multiple KPIs, and the processing unit is specifically configured to determine the uplink power control parameters of the multiple cells as optimization variables of the first optimization model; and determine a minimum weighted value of the multiple KPIs as an optimization target of the first optimization model.

With reference to the second aspect or any one of the foregoing implementation manners, in another implementation manner of the second aspect, the processing unit is specifically configured to map the optimization variables of the first optimization model from a discrete parameter space to a continuous parameter space, and convert a target function of the first optimization model into a continuous and smooth function, to acquire a second optimization model after conversion; determine a solution of the optimization variables in the continuous parameter space according to the second optimization model; and map the solution of the optimization variables in the continuous parameter space back to the discrete parameter space, to determine a solution of the optimization variables in the discrete parameter space.

With reference to the second aspect or any one of the foregoing implementation manners, in another implementation manner of the second aspect, the uplink power control parameters of the multiple cells include an uplink power control reference value of each cell of the multiple cells, and an uplink path loss compensation factor of each cell.

With reference to the second aspect or any one of the foregoing implementation manners, in another implementation manner of the second aspect, the at least one KPI of the network includes at least one of the following: uplink load, a CDBR, and an average uplink signal to interference plus noise ratio.

In the embodiments of the disclosure, by considering impact of uplink power control parameters of multiple cells on a KPI of a network on which the multiple cells are located, uplink power control parameters that are more optimized from the perspective of global performance of the network are obtained, thereby improving overall performance of the network.

### BRIEF DESCRIPTION OF DRAWINGS

To describe the technical solutions in the embodiments of the disclosure more clearly, the following briefly introduces the accompanying drawings required for describing the embodiments of the present application. Apparently, the accompanying drawings in the following description show merely some embodiments of the disclosure, and a person of ordinary skill in the art may still derive other drawings from these accompanying drawings without creative efforts.

FIG. 1 is a schematic flowchart of an uplink power control method according to an embodiment of the disclosure;

FIG. 2 is a schematic block diagram of an uplink power control apparatus according to an embodiment of the disclosure; and

FIG. 3 is a schematic block diagram of an uplink power control apparatus according to another embodiment of the disclosure.

### DESCRIPTION OF EMBODIMENTS

The following clearly describes the technical solutions in the embodiments of the disclosure with reference to the accompanying drawings in the embodiments of the present application. Apparently, the described embodiments are some but not all of the embodiments of the disclosure. All other embodiments obtained by a person of ordinary skill in the art based on the embodiments of the present invention without creative efforts shall fall within the protection scope of the present application.

It should be understood that the technical solutions of the present invention may be applied to various communications systems, such as: a Global System for Mobile Communications (GSM), a Code Division Multiple Access (CDMA) system, a Wideband Code Division Multiple Access (WCDMA) system, a general packet radio service (GPRS), a Long Term Evolution (LTE) system, a Long Term Evolution Advanced (LTE-A) system, and a Universal Mobile Telecommunications System (UMTS).

It should further be understood that in the embodiments of the disclosure, user equipment (UE) includes but is not limited to a mobile station (MS), a mobile terminal, a mobile telephone, a handset, portable equipment, and the like. The user equipment may communicate with one or more core networks by using a radio access network (RAN). For example, the user equipment may be a mobile telephone (or referred to as a “cellular” telephone), or a computer having a wireless communication function; the user equipment may further be a portable, pocket-sized, handheld, computer built-in, or vehicle-mounted mobile apparatus.

A key performance indicator (KPI) in the embodiments of the disclosure refers to a KPI of a cellular network, which may be, for example, uplink load, a call drop and block ratio (CDBR), and an average uplink signal to interference plus noise ratio of the network. The KPI is an important parameter of network performance. In the embodiments of the disclosure, when uplink power control is performed, a mapping relationship (such as a functional relationship) between uplink power control parameters of multiple cells in a network and one or more KPIs of the network is considered, to optimize the uplink power control parameters. The multiple cells may be all cells on the network, or cells that are located at key positions of the network and have a decisive effect on the KPI of the network, which are not specifically limited in the embodiments of the present invention.

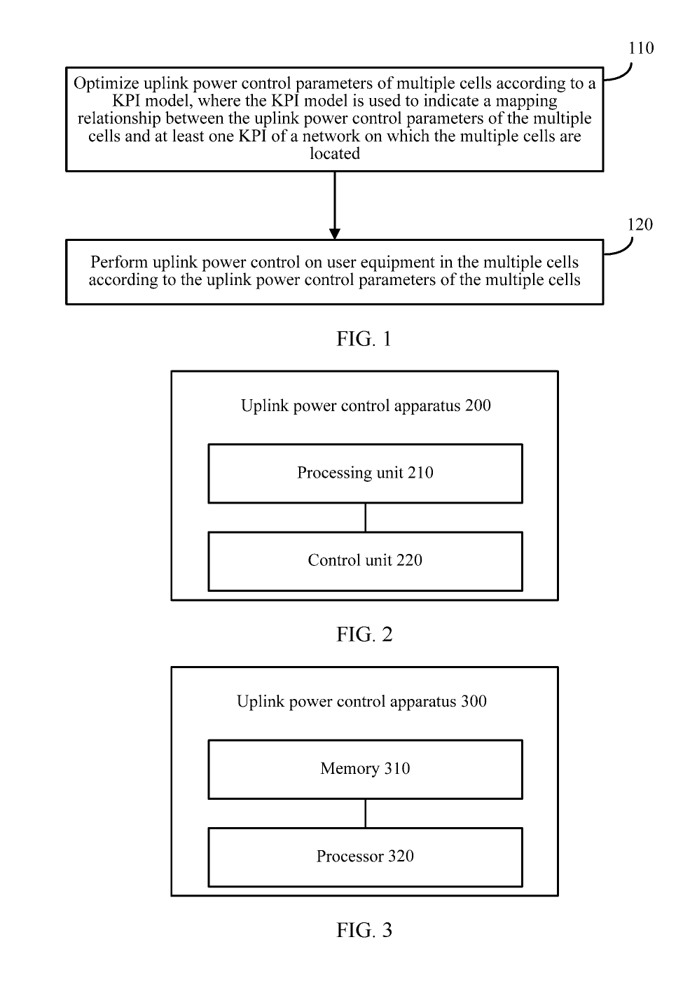

FIG. 1 is a schematic flowchart of an uplink power control method according to an embodiment of the disclosure. The method may be executed by a base station, or executed by an independent uplink power control apparatus. The method in FIG. 1 includes:

110: Optimize uplink power control parameters of multiple cells according to a KPI model, where the KPI model is used to indicate a mapping relationship between the uplink power control parameters of the multiple cells and at least one KPI of a network on which the multiple cells are located.

120: Perform uplink power control on user equipment in the multiple cells according to the uplink power control parameters of the multiple cells.

In this embodiment of the disclosure, by considering impact of uplink power control parameters of multiple cells on a KPI of a network on which the multiple cells are located, uplink power control parameters that are more optimized from the perspective of global performance of the network are obtained, thereby improving overall performance of the network.

It should be noted that, the at least one KPI in this embodiment of the present invention may be one KPI or may be multiple KPIs. Because KPIs may conflict with each other, that is, an increase in one KPI may lead to a decrease in another KPI, selecting multiple KPIs to perform joint optimization is more favorable to balance of overall network performance. In addition, a KPI selection manner is not specifically limited in this embodiment of the disclosure. For example, the KPI may include only uplink load, or a combination of uplink load and a CDBR, or may be a combination of other KPIs. It should also be noted that, during joint optimization involving multiple KPIs, weights of the KPIs may be adjusted according to an actual situation, for example, adjustment is performed according to priority levels of the multiple KPIs.

In this embodiment of the disclosure, the uplink power control parameters of the multiple cells may include: an uplink power control reference value of each cell of the multiple cells, and an uplink path loss compensation factor of each cell, and may further include an uplink power control parameter at another cell level.

It should be understood that, the KPI model in step 110 may be a functional relation, where the functional relation uses the uplink power control parameters of the multiple cells as independent variables and uses at least one KPI as a variable, and describes a mapping relationship between the KPI and the uplink power control parameters of the multiple cells.

It should be understood that, the optimizing uplink power control parameters of multiple cells according to a KPI model in step 110 may be: successively substituting, into the KPI model, values within a value range of the uplink power control parameters, to find a relatively optimized solution that meets a predetermined threshold condition of the KPI, or may be: creating an optimization model to determine an optimal solution of the power control parameters within a value range of the power control parameters. It should be understood that, the optimal solution may be locally optimal, or globally optimal.

Optionally, as an embodiment, the optimizing uplink power control parameters of multiple cells according to a KPI model in step 110 may include: creating a first optimization model according to the KPI model, where the first optimization model uses the uplink power control parameters of the multiple cells as optimization variables, and uses an optimal solution of the at least one KPI within a value range of the uplink power control parameter as an optimization target; and solving the first optimization model, to acquire uplink power control parameters of the multiple cells.

Optionally, as another embodiment, the at least one KPI may be multiple KPIs, and the creating a first optimization model according to the KPI model may include: determining the uplink power control parameters of the multiple cells as optimization variables of the first optimization model; and determining a minimum weighted value of the multiple KPIs as an optimization target of the first optimization model.

Specifically, when the at least one KPI is uplink load, the first optimization model may be shown in formula (1):

$$\{ \begin{matrix}{min}_{X} {Φ}_{LOAD} ( X ) \\ X = {( {{P}^{off}}^{V} , {α}^{V} )}^{T} , {{P}^{off}}^{V} = {( {p}_{1}^{off} , L , {p}_{C}^{off} )}^{T} , {α}^{V} = {( {α}_{1} , L , {α}_{C} )}^{T} \\ {p}_{c}^{off} ∈ \{ {p}_{min}^{off} , {p}_{min}^{off} + 1 , L , {p}_{max}^{off} \} , {α}_{c} ∈ \{ 0 , 0.4 , 0.5 , L , 1.0 \} , c ∈ C\end{matrix} \qquad ( 1 )$$

X is an optimization variable, and the optimization variable includes two parts, where one part is [symbol] ^{off} whose components include uplink power control reference values p_{c}^{off} of C cells (corresponding to the multiple cells in step 110); and the other part is [symbol] whose components include uplink path loss compensation factors α_{c} of C cells, where a value of c ranges from 1 to C. Values of p_{c}^{off} and α_{c} are both pre-defined discrete values, as shown in formula (1). An optimization target is min_{X} Φ_{LOAD}(X), that is, a minimum uplink load of the network.

Similarly, when the at least one KPI is a CDBR, the first optimization model may be shown in formula (2):

$$\{ \begin{matrix}{min}_{X} {Φ}_{CDBR} ( X ) \\ X = {( {{P}^{off}}^{V} , {α}^{V} )}^{T} , {{P}^{off}}^{V} = {( {p}_{1}^{off} , L , {p}_{C}^{off} )}^{T} , {α}^{V} = {( {α}_{1} , L , {α}_{C} )}^{T} \\ {p}_{c}^{off} ∈ \{ {p}_{min}^{off} , {p}_{min}^{off} + 1 , L , {p}_{max}^{off} \} , {α}_{c} ∈ \{ 0 , 0.4 , 0.5 , L , 1.0 \} , c ∈ C\end{matrix} \qquad ( 2 )$$

An optimization target is min_{X} Φ_{CDBR}(X), that is, a minimum CDBR of the network.

Certainly, the at least one KPI may be selected to be multiple KPIs, for example, joint optimization may be performed on uplink load and a CDBR. Then, the first optimization model may be shown in formula (3):

$$\{ \begin{matrix}{min}_{X} \{ Φ = {w}_{1} {Φ}_{LOAD} ( X ) + {w}_{2} {Φ}_{CDBR} ( X ) \} \\ X = {( {{P}^{off}}^{V} , {α}^{V} )}^{T} , {{P}^{off}}^{V} = {( {p}_{1}^{off} , L , {p}_{C}^{off} )}^{T} , {α}^{V} = {( {α}_{1} , L , {α}_{C} )}^{T} \\ {p}_{c}^{off} ∈ \{ {p}_{min}^{off} , {p}_{min}^{off} + 1 , L , {p}_{max}^{off} \} , {α}_{c} ∈ \{ 0 , 0.4 , 0.5 , L , 1.0 \} , c ∈ C\end{matrix} \qquad ( 3 )$$

An optimization target is min_{X} {Φ=w₁Φ_{LOAD}(X)+w₂Φ_{CDBR}(X)}, that is, a minimum weighted sum of the uplink load and CDBR of the network. Weighted values w₁ and w₂ may be determined according to factors such as priority levels of the uplink load and CDBR. For example, w₁+w₂=1, where in the network, if impact of the uplink load on performance of the entire network is greater than that of the CDBR, it may be set that w₁=0.7, and w₂=0.3.

It should be noted that, a specific manner of solving the first optimization model is not limited in this embodiment of the disclosure. Because values of the optimization variables are discrete (in an existing protocol, values of the uplink power control parameters are discrete values), and a target function is also discontinuous (including discontinuous functions such as min and max), a discrete optimizing manner may be used. For example, all discrete values within a value range of the optimization variables may be substituted into the optimization target to determine an optimal solution.

To solve the optimization problems (1) to (3), another common method, that is, a greedy algorithm, may be used. Specifically, a cell is randomly selected as an initial cell, and all possible values of uplink power control parameters ( [symbol] ^{off} and [symbol] ) of the cell are tried, to maximize performance of the cell (for example, minimize the load or minimize the CDBR), and the initial cell is added to a current cell set. Then, a neighboring cell of the cell is selected as a current cell. The current cell is added to the current cell set, and all possible values of uplink power control parameters of the current cell are tried, to maximize overall performance of the current cell set. The previous step is repeated until all cells are added to the current cell set, to finally determine values of uplink power control parameters of all the cells.

When all possible values of uplink power control parameters are tried to maximize the performance, one method is actually configuring a cell and measuring an actual performance indicator, and another method is estimating, by using a performance indicator model, a performance indicator that corresponds to a specific uplink power control parameter value. In order to determine a performance indicator model, a functional relation between an uplink power control parameter and a performance indicator needs to be created. Taking uplink load as an example, the uplink load may be expressed as follows:

Φ_{Load}=Σ_{c}δ_{c}, where δ_{c} is uplink load of a cell c and is expressed as follows:

$${δ}_{c} = {\sum }_{s ∈ S}^{ } {\int }_{{A}_{s , c}}^{ } \frac{{n}_{s ( c )}^{rb}}{{N}^{rb}} {ϒ}_{s ( c )} ( x ) d {T}_{s} ( x )$$

where:

S represents a set of service types provided by a network;

C represents a cell set;

A⊂ [symbol] ² represents a network coverage area;

A_{s,c}⊂A represents a distribution area of a service sεS within a cell cεC;

Tₛ represents distribution of a service sεS within a network area A⊂ [symbol] ²;

n_{s(d)}^{rb} represents a quantity of resource blocks used by a terminal that is located in xεA_{s,d} and requests a service sεS;

N^{rb} represents a total quantity of system resource blocks;

γ_{s(c)}(x) represents an average transmission time ratio of a terminal that is located in xεA_{s,c} and requests a service sεS, and γ_{s(c)}(x) is expressed as follows:

$${ϒ}_{s ( c )} ( x ) = \frac{{F}_{s ( c )}}{{B}_{s ( c )} ( x )}$$

where F_{s(c)} represents an uplink bandwidth requested by a terminal that is located in xεA_{s,c} and requests a service sεS;

B_{s(c)}(x) represents an uplink transmission bandwidth acquired by a terminal that is located in xεA_{s,c} and requests a service sεS, which uses [MHz] as a unit, and B_{s(c)} (x) is expressed as follows:

$${B}_{s ( c )} ( x ) = {η}_{s , c}^{BW} \frac{{n}_{s ( c )}^{rb}}{{N}^{rb}} W {log}_{2} ( 1 + \frac{SIN {R}_{s ( c )} ( x )}{{η}_{s , c}^{SIN R}} )$$

where SINR_{s(c)}(x) represents a SINR acquired by a terminal receiver that belongs to a cell cεC and requests a service sεS, and SINR_{s(c)}(x) is expressed as follows:

$$SIN {R}_{s ( c )} ( x ) := \frac{{N}^{rb}}{{n}_{s ( c )}^{rb}} \frac{{R}_{s ( c ) , c} ( x )}{{I}_{c}}$$

where η_{s,c}^{BW} represents a bandwidth efficiency factor of a service sεS within a cell cεC;

η_{s,c}^{SINR} represents a SINR efficiency factor of a service sεS within a cell cεC;

R_{s(d),c}(x) represents a power of a signal received by a cell cεC from a terminal that is located in xεA_{s,d} and requests a service sεS; R_{s(d),c}(x) uses [mW] as a unit, and is expressed as follows:

R_{s(d),c}(x)=10^{(P}^{_{s(d)}}^{-L}^{_{s(d),c}}^{(x))/10};

where P_{s(d)}(x) represents a transmit power of a terminal that is located in xεA_{s,d} and requests a service sεS, and P_{s(d)}(x) is expressed as follows:

P_{s(d)}(x)=min{P_{s(d)}^{max},P_{d}^{off}+α_{d}L_{s(d),d}(x)+10 log₁₀ n_{s(d)}^{rb}};

where L_{s(d),c}(x) represents a path loss between a cell cεC and a terminal that is located in xεA_{s,d} and requests a service sεS, and L_{s(d),c}(x) uses [dB] as a unit;

P_{s(d)}^{max} represents a maximum transmit power of a terminal that requests a service sεS, and Pₛ^{max} uses [dBm] as a unit; and

I_{c} represents an interference power received by a cell cεC, and I_{c} uses [mW] as a unit and is expressed as follows:

$${I}_{c} = {η}_{c}^{noise} + {\sum }_{d ∈ C \backslash \{ c \}}^{ } {\sum }_{s ∈ S}^{ } {\int }_{{A}_{s , d}}^{ } {λ}_{d} {γ}_{s ( d )} ( x ) {R}_{s ( d ) , c} ( x ) d {T}_{s} ( x )$$

$${λ}_{d} = \{ \begin{matrix}1 , & if {δ}_{d}^{max} \leq {δ}_{d} , \\ \frac{{δ}_{d}}{{δ}_{d}^{max}} , & otherwise ,\end{matrix}$$

where δ_{c}^{max} is a preset load threshold of a cell dεC.

Optionally, the solving the first optimization model may further include: mapping the optimization variables of the first optimization model from a discrete parameter space to a continuous parameter space, and converting a target function of the first optimization model into a continuous and smooth function, to acquire a second optimization model after conversion; determining a solution of the optimization variables in the continuous parameter space according to the second optimization model; and mapping the solution of the optimization variables in the continuous parameter space back to the discrete parameter space, to determine a solution of the optimization variables in the discrete parameter space. It should be understood that, the solution in the continuous parameter space may refer to a value, that is, values of the optimization variables in the continuous parameter space are mapped back to the discrete parameter space.

In this embodiment of the disclosure, a discrete and discontinuous optimization problem is converted into a continuous optimization problem, and therefore, the continuous optimization model can be solved by using an existing search algorithm (such as interior point methods) for the continuous optimization problem, thereby reducing a quantity of iterations, and improving solving efficiency of optimization.

It should be understood that, there may be multiple methods for mapping the solution in the continuous parameter space back to the discrete parameter space. For example, a shortest distance (such as an Euclidean distance) from the solution in the continuous parameter space to all values in the discrete parameter space is determined, and a solution in the discrete parameter space that has a shortest distance to the solution in the continuous parameter space is a final solution required. Certainly, a method of direct truncation may also be used, to search in the discrete parameter space for a solution that is greater than and closest to the solution in the continuous parameter space, and use the found solution as a final solution. The method is not specifically limited in this embodiment of the disclosure.

With reference to FIG. 1, the uplink power control method according to this embodiment of the disclosure is described in detail above. The following describes in detail an uplink power control apparatus according to an embodiment of the disclosure with reference to FIG. 2 to FIG. 3. The apparatus may be a base station, or may be an independent logical entity or apparatus.

FIG. 2 is a schematic block diagram of an uplink power control apparatus according to an embodiment of the disclosure. The uplink power control apparatus 200 includes a processing unit 210 and a control unit 220.

The processing unit 210 is configured to optimize uplink power control parameters of multiple cells according to a KPI model, where the KPI model is used to indicate a mapping relationship between the uplink power control parameters of the multiple cells and at least one KPI of a network on which the multiple cells are located.

The control unit 220 is configured to perform uplink power control on user equipment in the multiple cells according to the uplink power control parameters of the multiple cells that are acquired by the processing unit 210.

In this embodiment of the disclosure, by considering impact of uplink power control parameters of multiple cells on a KPI of a network on which the multiple cells are located, uplink power control parameters that are more optimized from the perspective of global performance of the network are obtained, thereby improving overall performance of the network.

In this embodiment of the disclosure, the uplink power control parameters of the multiple cells may include: an uplink power control reference value of each cell of the multiple cells, and an uplink path loss compensation factor of each cell, and may further include an uplink power control parameter at another cell level.

Optionally, as one embodiment, the processing unit 210 is specifically configured to create a first optimization model according to the KPI model, where the first optimization model uses the uplink power control parameters of the multiple cells as optimization variables, and uses an optimal solution of the at least one KPI within a value range of the uplink power control parameters as an optimization target; and solve the first optimization model, to acquire uplink power control parameters of the multiple cells.

Optionally, as another embodiment, the at least one KPI is multiple KPIs.

It should be noted that, the at least one KPI in this embodiment of the disclosure may be one KPI or may be multiple KPIs. Because KPIs may conflict with each other, that is, an increase in one KPI may lead to a decrease in another KPI, selecting multiple KPIs to perform joint optimization is more favorable to balance of overall network performance.

Optionally, as another embodiment, the processing unit 210 is configured to map the optimization variables of the first optimization model from a discrete parameter space to a continuous parameter space, and convert a target function of the first optimization model into a continuous and smooth function, to acquire a second optimization model after conversion; determine a solution of the optimization variables in the continuous parameter space according to the second optimization model; and map the solution of the optimization variables in the continuous parameter space back to the discrete parameter space, to determine a solution of the optimization variables in the discrete parameter space.

In this embodiment of the disclosure, a discrete and discontinuous optimization problem is converted into a continuous optimization problem, and therefore, the continuous optimization model can be solved by using an existing search algorithm (such as interior point methods) for the continuous optimization problem, thereby reducing a quantity of iterations, and improving solving efficiency of optimization.

Optionally, as another embodiment, the uplink power control parameters of the multiple cells include an uplink power control reference value of each cell of the multiple cells, and an uplink power loss compensation factor of each cell.

Optionally, as another embodiment, the at least one KPI of the network includes at least one of the following: uplink load, a CDBR, and an average uplink signal to interference plus noise ratio.

FIG. 3 is a schematic block diagram of an uplink power control apparatus according to another embodiment of the disclosure. The uplink power control apparatus 300 includes a memory 310 and a processor 320.

The memory 310 is configured to store an instruction that is required by the processor 320 during execution.

The processor 320 is configured to: optimize uplink power control parameters of multiple cells based on the instruction in the memory 310 according to a KPI model, where the KPI model is used to indicate a mapping relationship between the uplink power control parameters of the multiple cells and at least one KPI of a network on which the multiple cells are located; and perform uplink power control on user equipment in the multiple cells according to the uplink power control parameters of the multiple cells.

In this embodiment of the disclosure, the uplink power control parameters of the multiple cells may include: an uplink power control reference value of each cell of the multiple cells, and an uplink path loss compensation factor of each cell, and may further include an uplink power control parameter at another cell level.

Optionally, as an embodiment, the processor 320 is configured to create a first optimization model according to the KPI model, where the first optimization model uses the uplink power control parameters of the multiple cells as optimization variables, and uses an optimal solution of the at least one KPI within a value range of the uplink power control parameters as an optimization target; and solve the first optimization model, to acquire uplink power control parameters of the multiple cells.

Optionally, as another embodiment, the at least one KPI is multiple KPIs.

It should be noted that, the at least one KPI in this embodiment of the disclosure may be one KPI or may be multiple KPIs. Because KPIs may conflict with each other, that is, an increase in one KPI may lead to a decrease in another KPI, selecting multiple KPIs to perform joint optimization is more favorable to balance of overall network performance.

Optionally, as another embodiment, the processor 320 is configured to map the optimization variables of the first optimization model from a discrete parameter space to a continuous parameter space, and convert a target function of the first optimization model into a continuous and smooth function, to acquire a second optimization model after conversion; determine a solution of the optimization variables in the continuous parameter space according to the second optimization model; and map the solution of the optimization variables in the continuous parameter space back to the discrete parameter space, to determine a solution of the optimization variables in the discrete parameter space.

In this embodiment of the disclosure, a discrete and discontinuous optimization problem is converted into a continuous optimization problem, and therefore, the continuous optimization model can be solved by using an existing search algorithm (such as interior point methods) for the continuous optimization problem, thereby reducing a quantity of iterations, and improving solving efficiency of optimization.

Optionally, as another embodiment, the uplink power control parameters of the multiple cells include an uplink power control reference value of each cell of the multiple cells, and an uplink power loss compensation factor of each cell.

Optionally, as another embodiment, the at least one KPI of the network includes at least one of the following: uplink load, a CDBR, and an average uplink signal to interference plus noise ratio.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the disclosure, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the embodiments, but are not intended to limit the protection scope of the present application. Any variation or replacement readily figured out by a person skilled in the art within the technical scope disclosed in the disclosure shall fall within the protection scope of the present application. Therefore, the protection scope of the present application shall be subject to the protection scope of the claims.

What is claimed is:

1. An uplink power control method, comprising:
optimizing uplink power control parameters of multiple cells according to a key performance indicator (KPI) model, wherein the KPI model is used to indicate a mapping relationship between the uplink power control parameters of the multiple cells and at least one KPI of a network on which the multiple cells are located; and
performing uplink power control on user equipment in the multiple cells according to the uplink power control parameters of the multiple cells.

2. The uplink power control method according to claim 1, wherein the optimizing uplink power control parameters of the multiple cells according to a KPI model, comprises:
creating a first optimization model according to the KPI model, wherein the first optimization model uses the uplink power control parameters of the multiple cells as optimization variables, and uses an optimal solution of the at least one KPI within a value range of the uplink power control parameters as an optimization target; and
solving the first optimization model, to acquire uplink power control parameters of the multiple cells.

3. The uplink power control method according to claim 2, wherein the at least one KPI is multiple KPIs, and the creating a first optimization model according to the KPI model comprises:
determining the uplink power control parameters of the multiple cells as optimization variables of the first optimization model; and
determining a minimum weighted value of the multiple KPIs as an optimization target of the first optimization model.

4. The uplink power control method according to claim 2, wherein the solving the first optimization model comprises:
mapping the optimization variables of the first optimization model from a discrete parameter space to a continuous parameter space, and converting a target function of the first optimization model into a continuous and smooth function, to acquire a second optimization model after conversion;
determining a solution of the optimization variables in the continuous parameter space according to the second optimization model; and
mapping the solution of the optimization variables in the continuous parameter space back to the discrete parameter space, to determine a solution of the optimization variables in the discrete parameter space.

5. The uplink power control method according to claim 1, wherein the uplink power control parameters of the multiple cells comprise an uplink power control reference value of each cell of the multiple cells, and an uplink path loss compensation factor of each cell.

6. The uplink power control method according to claim 1, wherein the at least one KPI of the network comprises at least one of the following:
uplink load, a call drop and block ratio (CDBR), and an average uplink signal to interference plus noise ratio.

7. An uplink power control apparatus, comprising:
a processor, configured to:
optimize uplink power control parameters of multiple cells according to a key performance indicator (KPI) model, wherein the KPI model is used to indicate a mapping relationship between the uplink power control parameters of the multiple cells and at least one KPI of a network on which the multiple cells are located, and
perform uplink power control on user equipment in the multiple cells according to the uplink power control parameters of the multiple cells that are acquired by the processor;
a memory, configured to store an instruction that is required by the processor during execution.

8. The uplink power control apparatus according to claim 7, wherein the processor is further configured to:
create a first optimization model according to the KPI model, wherein the first optimization model uses the uplink power control parameters of the multiple cells as optimization variables and uses an optimal solution of the at least one KPI within a value range of the uplink power control parameters as an optimization target; and
solve the first optimization model, to acquire uplink power control parameters of the multiple cells.

9. The uplink power control apparatus according to claim 7, wherein the at least one KPI is multiple KPIs, and the processor is further configured to:
determine the uplink power control parameters of the multiple cells as optimization variables of the first optimization model, and
determine a minimum weighted value of the multiple KPIs as an optimization target of the first optimization model.

10. The uplink power control apparatus according to claim 8, wherein the processor is further configured to:
map the optimization variables of the first optimization model from a discrete parameter space to a continuous parameter space, and convert a target function of the first optimization model into a continuous and smooth function, to acquire a second optimization model after conversion;
determine a solution of the optimization variables in the continuous parameter space according to the second optimization model; and
map the solution of the optimization variables in the continuous parameter space back to the discrete parameter space, to determine a solution of the optimization variables in the discrete parameter space.

11. The uplink power control apparatus according to claim 7, wherein the uplink power control parameters of the multiple cells comprise an uplink power control reference value of each cell of the multiple cells, and an uplink path loss compensation factor of each cell.

12. The uplink power control apparatus according to claim 7, wherein the at least one KPI of the network comprises at least one of the following:
uplink load, a call drop and block ratio (CDBR), and an average uplink signal to interference plus noise ratio.
